(19) United States
(12) Patent Application Publication
(10) Pub. No.: US 2007/0013100 A1
(43) Pub. Date: Jan. 18, 2007

(54) Method for producing plastic film

(76) Inventors: Kevin Patrick Capaldo, Mount Vernon, IN (US); Dennis Joseph Coyle, Clifton Park, NY (US); Yu Hu, Evansville, IN (US); Haijiang Tang, Guangdong (CN); Yan Zhang, Shanghai (CN)

Correspondence Address: CANTOR COLBURN, LLP, 55 GRIFFIN ROAD SOUTH, BLOOMFIELD, CT, 06002, US

(21) Appl. No.: 11/180,857

(22) Filed: Jul. 13, 2005

(51) Int. Cl. B29C 47/00

(52) U.S. Cl. 264/210.2

(57) ABSTRACT

In one embodiment, the film making process can comprise: introducing a plastic melt to a nip between a calendar roll and a resilient roll, passing the plastic melt between the calendar roll and the resilient roll to produce the film, and controlling a roughness of the film by actively cooling an external surface of the resilient roll. In another embodiment, the film making process can comprise: introducing a plastic melt having a melt temperature to a nip between a calendar roll and a resilient roll, passing the plastic melt between the calendar roll and the resilient roll to produce the film, and adjusting a roughness of the film at a constant production rate and a constant nip pressure.

### BACKGROUND OF THE INVENTION

In flat panel displays (e.g., backlight computer displays), optical film (which can also be referred to as a sheet, layer, foil, and the like) materials are commonly used, for example, to direct, diffuse, or polarize light. For example, in backlight displays, brightness enhancement films use prismatic structures on the surfaces thereof to direct light along a viewing axis (i.e., an axis normal (perpendicular) to the display). This enhances the brightness of the light viewed by the user of the display and allows the system to consume less power in creating a desired level of on-axis illumination. Such films can also be used in a wide range of other optical designs, such as in projection displays, traffic signals, and illuminated signs.

Currently, backlight displays, for example, employ a plurality of films arranged in a manner to obtain the desired brightness and diffusion of the light directed to the viewer. There is a desire to develop a method to produce optical polymer films with controllable haze and low stress at a high production rate. On production lines, production rates have been low, i.e., limited to 20 feet per minute (ft/min), in order to attain a haze of 40% for textured polycarbonate (PC) films with a thickness of 7 mils.

### SUMMARY OF THE INVENTION

Disclosed herein are processes for making an optical plastic film and the film made therefrom.

In one embodiment, the film making process can comprise: introducing a plastic melt to a nip between a calendar roll and a resilient roll, passing the plastic melt between the calendar roll and the resilient roll to produce the film, and controlling a roughness of the film by actively cooling an external surface of the resilient roll.

In another embodiment, the film making process can comprise: introducing a plastic melt having a melt temperature to a nip between a calendar roll and a resilient roll, and passing the plastic melt between the calendar roll and the resilient roll to produce the film. A point near and subsequent to where the melt contacts the resilient roll is maintained at a roll temperature equal to the melt temperature minus a reduction temperature, and the reduction temperature is greater than or equal to about 100° F.

In another embodiment, film making process can comprise: introducing a plastic melt to a nip between a calendar roll and a resilient roll, actively cooling an external surface of the resilient roll, and passing the plastic melt between the calendar roll and the resilient roll at a roll rate of greater than or equal to about 25% greater than a standard rate and attaining a rate surface roughness. The rate surface roughness can be substantially equal to about a slow surface roughness attained if the same plastic melt is passed through the same calendar roll and the same resilient roll at the standard rate and without actively cooling the external surface.

In yet another embodiment, a film making process can comprise: introducing a plastic melt having a melt temperature to a nip between a calendar roll and a resilient roll, passing the plastic melt between the calendar roll and the resilient roll to produce the film, and adjusting a roughness of the film at a constant production rate and a constant nip pressure.

The above described and other features are exemplified by the following figures and detailed description.

### BRIEF DESCRIPTION OF THE DRAWINGS

Refer now to the figures, which are meant to be exemplary and not limiting, and wherein like elements are numbered alike.

FIG. 1 illustrates a film manufacturing process employing a chill roll.

FIG. 2 illustrates a film manufacturing process employing an air knife.

FIG. 3 is a graphical illustration of the dependence of haze on resilient roll surface temperature.

### DETAILED DESCRIPTION OF THE INVENTION

It is noted that the terms “first,” “second,” and the like, herein do not denote any amount, order, or importance, but rather are used to distinguish one element from another, and the terms “a” and “an” herein do not denote a limitation of quantity, but rather denote the presence of at least one of the referenced item. Additionally, all ranges disclosed herein are inclusive and combinable (e.g., the ranges of “up to 25 wt %, with 5 wt % to 20 wt % desired,” are inclusive of the endpoints and all intermediate values of the ranges of “5 wt % to 25 wt %,” etc.). The notation “±10%” means that the indicated measurement may be from an amount that is minus 10% to an amount that is plus 10% of the stated value. As used herein the term “about”, when used in conjunction with a number in a numerical range, is defined being as within one standard deviation of the number “about” modifies. As used herein, the terms film and sheet are used interchangeable and refer to the thermoplastic material having a final thickness of about 0.0005 inches (0.0127 millimeters (mm)) to about 0.060 inches (in) (1.52 mm), or thicker, depending on the final application. Unless otherwise specified, the haze and roughness values set forth herein are average values.

In order to maintain a desired optical retardation (e.g., residual stress) and optical retardation gradient (e.g., optical retardation change per unit distance), in the final film, at least one of the calendaring rolls comprises a resilient material, e.g., an elastomeric material, such as rubber (e.g., an EPDM (ethylene propylene diamine monomer) based rubber, silicone, and the like), and/or the like. The optical retardation can be a low optical retardation of less than or equal to about 50 nanometers (nm), while the optical retardation gradient can be less than or equal to about 50 nanometer per inch (nm/in). In various embodiments, this roll can be made entirely of the resilient material. Alternatively, the resilient material can be disposed on an outer surface of the roll, i.e., the surface of the roll that will be disposed in physical communication with the film. Texture finishing of the resilient roll can be about 0.1 micrometers (μm) to about 5.0 μm in roughness (Ra) using Surfometer model PDD-400-CO according to ASME B46.1-1995, or, more specifically about 0.3 μm to about 1.5 μm. Although various resilient materials can be employed, a silicone resilient roll having a roughness of about 0.4 μm to about 1.0 μm can be employed to produce, at a rate of greater than or equal to about 50 feet per minute (ft/min) (15.2 meters per minute (m/min)), a 0.05 mm to about 0.25 mm thick film having a roughness of about 0.3 μm to about 0.8 μm.

In addition to attaining a desired optical retardation, haze and line speed are also important factors in film production. Although low optical retardation can be attained, in order to attain a desired haze (e.g., a haze of less than or equal to about 40%), the maximum line speed was far below a satisfactory (i.e., commercially acceptable) level. In some cases, the line speeds of less than or equal to 20 feet per minute (ft/min; 6.1 meters per minute (m/min)) were needed to attain haze values of less than or equal to 40%. Unless otherwise noted, all haze values are measured according to ASTM D1003-95 using a BYK-Gardner haze meter Model Number HB-4725.

It is noted that the percent haze can be predicted and calculated from the following equation:

$$\% Haze = 100 \times \frac{Total Diffuse Transmission}{Total Transmission} \qquad ( 1 )$$

wherein the total transmission is the integrated transmission; and the total diffuse transmission is the light transmission that is scattered by the film as defined by ASTM D1003.

It was discovered that the line speed could be substantially improved while retaining a low optical retardation and a target haze by controlling the outer surface temperature of the resilient roll. The external surface temperature of the resilient roll can be maintained below the softening point of the melt, and, more specifically controlled to attain a desired haze and/or roughness value. For a melt comprising polycarbonate, for example, the external surface temperature of the resilient roll, at a point on the roll opposite the nip, can be less than or equal to about 200° F. (93° C.), or, more specifically, less than or equal to about 175° F. (79° F.). The external surface temperature of the resilient roll can be sufficiently reduced, such that, for the particular melt composition, a desired final haze and/or roughness value can be attained at a desired line speed. The external surface temperature of the resilient roll, at a point on the roll prior to the nip (i.e., after the point where the roll is cooled), can have a surface temperature equal to the glass transition temperature of the melt minus greater than or equal to about 100° F. (38° C.), or, more specifically, a surface temperature equal to the glass transition temperature of the melt minus greater than or equal to about 100° F. (38° C.), or, more specifically, a surface temperature equal to the glass transition temperature of the melt minus greater than or equal to about 125° F. (52° C.), or, even more specifically, a surface temperature equal to the glass transition temperature of the melt minus greater than or equal to about 150° F. (65° C.).

Controlling the surface temperature of the resilient roll can comprise cooling the outer surface of the resilient roll with external cooling devices. Due to the low thermal conductivity of the resilient material, internal cooling of the resilient roll is, alone, insufficient to cool the outer surface of the resilient roll to enable haze control. Therefore, external cooling device(s), i.e., cooling roll(s), gas streams, and the like, as well as combinations comprising at least one of the foregoing external cooling devices, can be employed to reduce the surface temperature of the resilient roll to control the haze value as desired.

Not to be limited by theory, it has been determined, that due to the poor thermal conductivity of the resilient materials of the resilient roll, the polymer melt can not be cooled sufficiently quickly after touching on the roll surface. Inasmuch as the slow cooling of the molten thermoplastic, for an example, polycarbonate (PC), affects the optical properties, undesirable haze and gloss values can be detrimentally produced. More specifically, the slower cooling caused by the relatively low thermal conductivity of the resilient roll, prevents heat from being conducted away from the roll surface and causes the surface of the roll to develop an elevated temperature. This elevated surface temperature of the rubber roll causes the polymer to remain soft to the degree that it more accurately replicates the texture of the rubber surface, thus producing a polymer film of higher roughness and higher haze.

Controlling the haze using chill roll(s) can comprise contacting the surface of the resilient roll with the surface of the chill roll, during the processing of the film. The chill roll is maintained at a sufficient temperature and in contact with the surface under a sufficient pressure (i.e., the pressure between the chill roll and the resilient roll), and has a sufficient size, to sufficiently cool the surface of the resilient roll to a temperature that enables the production of a film comprising a desired haze value at a desired production rate. For example, a film can be produced at a line rate of greater than or equal to about 15 m/min while producing a film with a haze of less than or equal to about 40%. The temperature of chill roll, for example, can be less than or equal to about 60° C., or, more specifically, less than or equal to about 40° C., or, even more specifically, about 5° C. to about 40° C. The pressure between chill roll and rubber roll can be about 2 pounds per linear inch (PLI) to about 10 PLI, or, more specifically, about 2 PLI to about 6 PLI, or, even more specifically, about 5 PLI to about 6 PLI. Higher nip force could increase the contact area and thus gives rise to more cooling. However, it's objective to control the nip pressure between chill roll to rubber roll under a low ratio (≦10%) to the pressure between rubber roll and metallic chrome roll, which can be about 40 to about 50 PLI. We note that these ranges are specific to the exact mechanical set-up used in these examples, which used an external mechanical force mechanism which transmitted the chill roll nip force all the way through to the calendering nip and thus to the plastic film being processed. The chill roll nip mechanism can, however, be changed to isolate this nip force from the calendering nip, thus allowing higher chill roll nip forces and more effective rubber roll surface cooling.

Alternatively, or in addition, controlling the haze using a flow of gas (e.g., with an air knife and/or the like) can comprise contacting the surface of the resilient roll with the flow of a gas (e.g., air, an inert gas, and/or the like), during the processing of the film. The gas stream is maintained at a temperature and at a sufficient flow rate, to sufficiently cool the surface of the resilient roll to a temperature that enables the production of a film comprising a desired haze value at a desired production rate. The temperature of the gas stream (e.g., compressed air) can be less than or equal to about 60° C., or more specifically about 5° C. to about 30° C. The gas stream flow rate can be greater than or equal to about 5 meters per second (m/sec), or, more specifically, about 5 m/sec to about 25 m/sec, or, even more specifically, about 5 m/sec to about 20 m/sec. The pressure of the gas stream entering the gas flow device can be about 10 pounds per square inch (psi) to about 120 psi, or, more specifically, about 10 psi to about 75 psi, or, even more specifically about 15 psi to about 30 psi.

For simplicity and efficiency, the gas can be air supplied, for example, by an air knife. The air can be directed at the resilient roll surface at a temperature of about 20° C. to about 25° C. (i.e., room temperature). Alternatively, the air can be cooled, e.g., with a heat exchanger, or the like. The gas can also be directed at the surface at various angles, e.g., the gas can be directed such that the gas contacts the surface at an angle of about 5 degrees to about 90 degrees, or, more specifically, about 45 degrees to about 90 degrees, wherein each gas stream can be directed at the same or a different angle at the surface. For example, multiple air knives can direct multiple gas streams at the surface of the resilient roll to attain a desired temperature profile across the roll and therefore a desired haze value in the final film.

The second calendering roll can be another resilient roll or can be a rigid roll with either a textured or a polished surface. The rigid calendering roll can, for example, be chrome, chromium plated, steel, steel plated, and the like, as well as combinations comprising at least one of the foregoing. If a second resilient roll is employed, additional chill roll(s) and/or gas stream(s) can be employed accordingly.

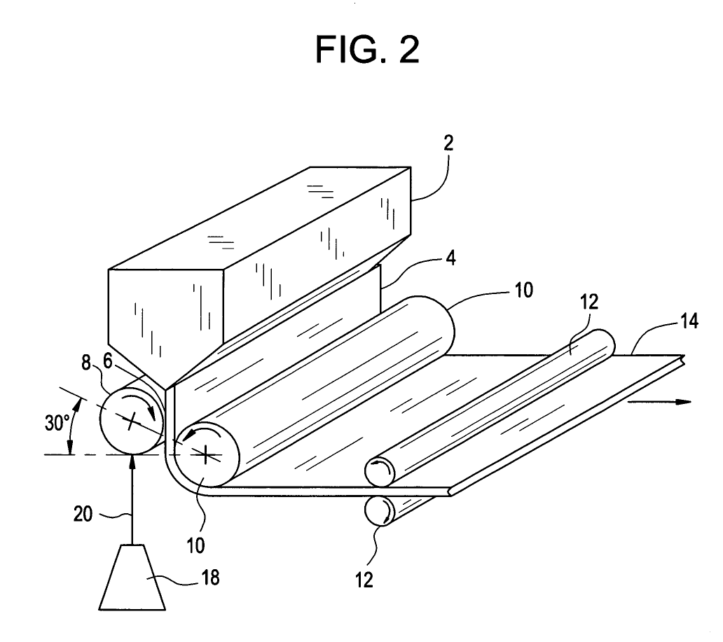

The calendering rolls can essentially lie in a horizontal plane (i.e., essentially perpendicular to the downward extrusion of the thermoplastic resin) or in a vertical plane, to form the finished film. In another embodiment, the calendering rolls may lie in a horizontal plane or in a plane at any angle of 0° (horizontal; essentially perpendicular to the plane of the downward extruding molten resin) to about 45° from the horizontal, or, more specifically, about 0° to about 30° from the horizontal. (See FIG. 2)

The composition of the film can be an optical transparent material (i.e., a material having a light transmission greater than 80%) that can be formed into a film with calendering rolls. For example, the plastic can be a thermoplastic such as polycarbonate, polyethylene, poly(ethylene terephthalate) (PET), including, but not limited to, homopolymers, copolymers, and compositions comprising at least one of the foregoing thermoplastics, as well as reaction products of compositions that comprised at least one of the foregoing. The thermoplastic polycarbonate resin that can be employed in producing the polycarbonate film is not limited. For example, the thermoplastic polycarbonate resin can be an aromatic homo-polycarbonate resin. Other polycarbonate resins may be obtained by the reaction of an aromatic dihydroxy compound with a carbonate precursor such as a diaryl carbonate. An exemplary aromatic dihydroxy compound is 2,2-bis(4-hydroxy phenyl) propane (i.e., bisphenol-A (BPA)).

The polycarbonate can be combined with polyester-polycarbonate, also known as a copolyester-polycarbonate or polyester carbonate. In one embodiment, polyester-polycarbonates as used herein can be weatherable compositions comprising resorcinol (e.g., isophthalate terephthalate resorcinol, and the like, as well as reaction products of resorcinol).

The process of producing the film can comprise melting a plastic (e.g., by feeding a plastic to an extruder and heating the plastic to form an extrudable melt). The melt can be extruded (e.g., downwardly) through an orifice of an extrusion nozzle (e.g., a slot or the like), into the nip (also know as the gap) between a pair of calendering rolls. (It is understood that extrusion is intended to also include co-extrusion of the optical plastic with another material, wherein the optical plastic contacts the resilient roll.) The extruded melt can form a continuous film of molten plastic (extrudate) that can be passed through the nip.

The calendering rolls can be maintained at a temperature that enables the formation of the film without causing the film to adhere to the rolls. For example, the interior surface of the metal calendering roll can be maintained at a temperature of less than or equal to about 140° C., or, more specifically, about 85° C. to about 130° C., or, even more specifically, about 110° C. to about 130° C. Optionally, the interior surface of the resilient calendering roll can be maintained at a temperature of less than or equal to about 50° C., or, more specifically, of about room temperature to about 50° C.

For example, the process can comprise feeding a resin (e.g., polycarbonate) to an extruder at a temperature above its glass transition temperature (T_{g}). The molten resin advances through the extruder and extrudes (e.g., extrudes downwardly) through the orifice of an extrusion nozzle (also known as a die) into the nip between two calendering rolls maintained below the T_{g} of the resin. The resin cools to below its glass transition temperature while it passes between the rolls to form the film that can optionally be stored or further processed as desired.

Based upon the desired haze of the film and the combination of cooling device(s) employed, the line speed of the rolls can be adjusted. For production efficiencies, maximum line speeds attainable while producing a film comprising the desired combination of properties (e.g., optical retardation and haze), are generally employed. Even for the production of a film having a haze value of less than or equal to about 40% at a film thickness of about 7 mils (0.18 millimeters (mm)), the line speed of the rolls (and therefore the speed of the film exiting the rolls), can be greater than or equal to about 40 feet per minute (ft/min; 12.2 meters per minute (m/min)), or, more specifically, greater than or equal to about 50 ft/min (15.2 m/min), or, even more specifically, greater than or equal to about 60 ft/min (18.3 m/min), or, yet more specifically, greater than or equal to about 80 ft/min (24.4 m/min), and even greater than or equal to about 90 ft/min (27.4 m/min). To attain this desired line speed and to attain a film with a desired haze of less than or equal to about 80%, or, more specifically, about 5% to about 60%, the surface of the resilient roll is cooled. Alternatively, a desired roughness (e.g., for opaque films) can be attained, wherein a relationship of haze to roughness is illustrated in Table 1.

TABLE 1

| average Haze (%) | Ra (μm) |
|---|---|
| 30 | 0.30226 |
| 34.5 | 0.35306 |
| 35 | 0.35306 |
| 43.5 | 0.38354 |
| 44.1 | 0.3937 |
| 44.4 | 0.3937 |
| 49.7 | 0.43434 |
| 50.6 | 0.44958 |
| 51.6 | 0.45212 |
| 59 | 0.66802 |
| 59.9 | 0.67818 |
| 62 | 0.68834 |
| 68.7 | 0.75184 |
| 69.9 | 0.75692 |
| 70.6 | 0.80518 |

The resultant film has low optical retardation (e.g., less than or equal to about 50 nm), low optical retardation gradient (e.g., less than or equal to 50 nm/in), and desired haze (e.g., less than or equal to about 80%). The retardation of the resultant film can be less than or equal to about 50 nm, or, more specifically, less than or equal to about 30 nm, and more particularly less than or equal to about 20 nm. Optical retardation can be measured using, for example, a SCA1500 System from Strainoptic Technologies (now Strainoptic, Inc.) according to ASTM D4093-95. Stated another way, the optical retardation gradient is the first derivative of the optical retardation profile and can be less than or equal to about 50 nm/in.

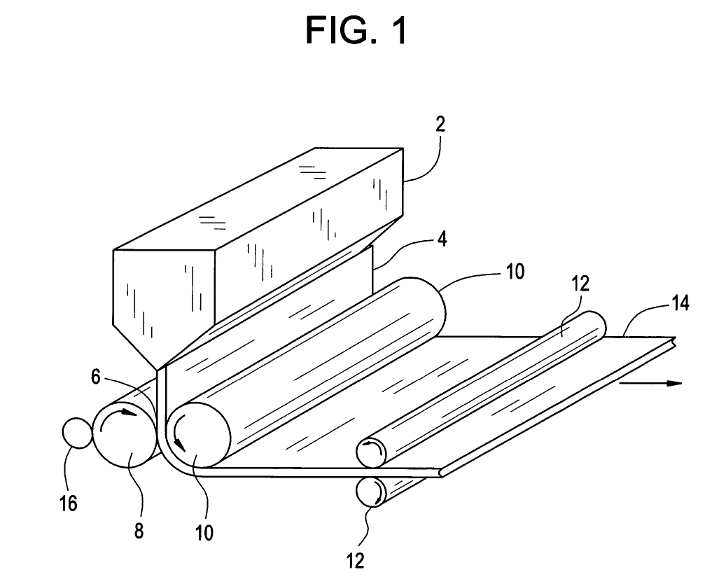

FIG. 1 illustrates a film manufacturing process employing a chill roll, showing extrusion nozzle 2 extruding molten plastic 4. The extruded melt 4 passes through nip 6 formed by calendering rolls 8 and 10, is cooled, and then passed through pull rolls 12. Chill roll 16 contacts the resilient calendering roll 8, cooling the surface thereof.

FIG. 2 illustrates a film manufacturing process employing an air knife, showing extrusion nozzle 2 extruding molten plastic 4. The extruded melt 4 passes through nip 6 formed between calendering rolls 8 and 10, cooling film 4, and pull rolls 12. The air knives 18 direct streams of air 20 directly at the resilient calendering roll 8, cooling the roll. Here, the air knives 18 cool the roll directly, and do not cool the resin directly; i.e., the air streams do not contact the resin prior to contacting the resilient roll surface. Cooled finished film 14 can be sent to storage or further processed. In this embodiment, rolls 8 and 10 are illustrated as in a plane at an angle of 30° from the horizontal.

The following example is provided merely to show one skilled in the art how to apply the principals discussed herein. This example is not intended to limit the scope of the claims appended hereto.

### EXAMPLES

### Example 1

Polycarbonate (PC) resins were extruded at 270° C. into base films comprising a thickness of about 175 micrometers. The film was extruded between a polished chrome calendering roll maintained at 127° C. and a steel calendering roll coated with 0.5 inch (about 1.3 centimeters (cm)) thick, 70 durometer (Shore A) silicone rubber. Both rolls were internally cooled with water at temperature of 43° C. A base film was achieved with optical retardation gradient of 7.2 nm/in retardation and 40% haze at a line speed of 19 feet per minute (ft/min) (about 5.8 meters per min (m/min)). It is noted that in constructing a stress profile from which the optical retardation gradient was obtained, optical retardation was measured at every 0.25 inches (0.64 centimeters) across the length of the film.

### Example 2

PC films were prepared with line speed of 66 ft/min (20 m/min). The haze of PC films varied between 36% and 90% (as measured by ASTM D1003) using air life cooling with different air velocity at different cooling locations on rubber roll surface. The haze values of PC films showed a good correlation with the resilient rubber roll surface temperature, as shown in FIG. 3. The air knife was installed underneath the rubber to facilitate the easy installation from a manufacturing point of view. The velocity of the air flow was kept below 8 meter per second (m/s) to reduce risk of disturbing the polymer melts.

### Example 3

PC films were prepared with a line speed of 49 ft/min (15 m/min). The haze of PC films varied between 15% and 60% after applying the cooling techniques specified in Table 1.

### Example 4

PC films were prepared with line speed of 10 m/min. PC films had haze of 19% to 42%, using the cooling techniques specified in Table 2.

TABLE 2

| | | | | Rubber Roll | | |
|---|---|---|---|---|---|---|
| | | | | Surface | | Optical |
| | Sample | Cooling | Line Speed | Temperature | | retardation |
| Example | No. | Condition | (ft/min) | (° C.) | Haze (%) | (nm) |
| Example 2 | 1 | No cooling^{a} | 66 | 132.3 | 90 | 22.5 |
| | 2 | air knife^{1,a} | 66 | 80.7 | 36 | 20.2 |
| | 3 | chill roll^{2,b} | 66 | 100 | 40.6 | 32 |
| Example 3 | 4 | No cooling^{b} | 49 | 117.1 | 60 | 12.4 |
| | 5 | air knife^{1,b} | 49 | 73.5 | 15 | 13.3 |
| | 6 | chill roll^{2.b} | 49 | 93.1 | 30.6 | 21.5 |
| Example 4 | 7 | No cooling^{b} | 33 | 98.5 | 42 | 16.9 |
| | 8 | air knife^{1,b} | 33 | 62.9 | 19 | 10.5 |
| | 9 | chill roll^{2,b,c} | 33 | 88.2 | 15.8 | 16.9 |

¹air was directed at the rubber roll at an angle of 90°, a temperature of 25° C., a rate of 7.2 meters per second (m/s), and a pressure of the air supply to the air knife of 29 psi, with a distance from the nozzle of the air knife to the rubber roll of 2 inches.
²the chill roll was maintained at a temperature of 15° C., with a pressure between the chill roll and rubber roll of 5 PLI.
^{a}nip force between the calender rolls was 57 PLI.
^{b}nip force between the calender rolls was 40 PLI.
^{c}film thickness is 10 mil (0.254 millimeters (mm)). The thickness of other samples is 7 mil (0.18 mm).

As can be seen from Table 2, even at a rate of 33 ft/min (10 m/min), without cooling of the rubber roll, attaining a haze of less than or equal to 40% was difficult. However, comparison of Sample 7 (no cooling and a rate of 33 ft/min) to Sample 3 (chill roll and a rate of 66 ft/min), the production rate doubled, while maintaining haze around 40% after applying the cooling technique. It is further noted that, as can be see from the use of the air knife versus the chill roll, a reduced optical retardation can be attained. Namely, even at rates of 66 ft/min, an optical retardation of less than or equal to about 25 nm is maintained with haze values of less than or equal to about 60, or, more specifically, an optical retardation of less than or equal to about 22 nm is maintained with haze values of less than or equal to 60, or, even more specifically, an optical retardation of less than or equal to about 22 nm is maintained with haze values of less than or equal to 40.

This data also supports the unexpected discovery that the haze (and roughness) of resin films (e.g., polycarbonate films) is controllable at a constant production rate (in other words, the haze of a film can be controlled without changing the production rate), while the optical retardation remains at an acceptable level. For example, referring to Example 3 (Samples 4-6), the haze can be adjusted within the range of 15% to 60% at the same production rate (e.g., at 49 ft/min), while retaining the optical retardation at less than 25 nm.

### Example 5

PC films were prepared with line speed of 66 ft/min (20 m/min), a nip force between rubber roll and chrome roll of 23 PLI (e.g., a nip pressure of less than half of the nip pressure of Sample 1 in Table 2), and no cooling of the rubber roll. The haze of PC films as prepared was about 60% (as measured by ASTM D1003-95). Even though the haze value of the prepared PC films dropped from 90% at the same line speed as Sample 1, the cosmetic property of the said film was out of the requirements for optical films. Lots of cosmetic defects, including color band, grinding lines and/or the like, were discernable on the prepared PC films. Hence, reducing the nip pressure between the rubber roll and chrome roll did not produce an acceptable film having the desired haze; the film had cosmetic defects.

Although many factors can affect haze, adjustment of the factors can result in other undesirable side-effects (such as color band, grinding lines, gauge band, and/or the like), while failing to increase line speed. Here, however, it was unexpectedly discovered that, by cooling the outer surface of the resilient roll, a film (e.g., a film having a thickness of about 0.05 mm to about 0.30 mm), could be produced at a high production rate (e.g., greater than or equal to about 49 ft/min (15 m/min), more specifically, greater than or equal to about 66 ft/min (20 m/min), and even greater than or equal to about 98 ft/min (30 m/min)), while producing a film having a haze of less than or equal to about 40% (and even less than or equal to 30%). This film further has an optical retardation gradient of less than or equal to about 50 nm/in, or, more specifically, less than or equal to about 40 nm/in, even more specifically, less than or equal to about 30 nm/in, and yet more specifically less than or equal to about 15 nm/in. In other words, without the introduction of the undesirable side-effects, haze/surface roughness can be controlled, line speeds can be increased, and low optical retardation can be retained.

It has been discovered that a film can be produced with substantially the same properties at significantly faster rates. For example, a film (e.g., a polycarbonate film, etc.) can be produced by forming a plastic melt and introducing the plastic melt to a nip between a calendar roll and a resilient roll. An external surface of the resilient roll is actively cooled (i.e., the cooling is not passive cooling due to the general environment, but is actively applied to the roll, e.g., with a chill roll, fluid stream, and/or the like). The plastic melt can then be passed through the roll at an accelerated rate while attaining substantially the same properties (e.g., the difference in the properties is about ±5% change). For example, at a roll rate of greater than or equal to about 25% greater than a standard rate, a rate surface roughness can be obtained. The rate surface roughness is substantially equal to about a slow surface roughness attained if the same plastic melt was passed through the same calendar roll and the same resilient roll at the standard rate (and at the same melt temperature and nip pressure) and without actively cooling the external surface. Actually, substantially the same properties can be attained at a roll rate of greater than or equal to about 50% greater than the standard rate, even at greater than or equal to about 100% greater than the standard rate, and in some cases, even at greater than or equal to about 200% greater than the standard rate. In other words, if the standard rate is 10 ft/min to attain properties (e.g., a surface roughness of X), with the active cooling, using the same rolls, at the same nip pressures, substantially the same properties can be attained at rates of greater than or equal to about 12.5 ft/min, greater than or equal to about 15 ft/min, greater than or equal to about 20 ft/min, and possibly even greater than or equal to about 30 ft/min.

The present process further enables the production of a film at substantially the same rates with significantly reduced haze and roughness. For example, a film (e.g., a polycarbonate film, etc.) can be produced by forming a plastic melt and introducing the plastic melt to a nip between a calendar roll and a resilient roll. The plastic melt can then be passed through the nip between the rolls to produce a film having a first haze/roughness value. This first haze/roughness value can be adjusted (e.g., reduced), without changing the melt temperature, roll speed, or nip pressure, by actively cooling an external surface of the resilient roll. For example, a haze/roughness of a film can be reduced by greater than or equal to about 25%, or, more specifically, greater than or equal to about 40%, or, more specifically, greater than or equal to about 50%, or, more specifically, greater than or equal to about 60%, and even or, more specifically, greater than or equal to about 75%, compared to a haze/roughness value determined with the same calendar roll and the same resilient roll at the same rate, same melt temperature, and same nip pressure, and without actively cooling the external surface.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

### Example 2

PC films were prepared with line speed of 66 ft/min (20 m/min). The haze of PC films varied between 36% and 90% (as measured by ASTM D1003) using air knife cooling with different air velocity at different cooling locations on rubber roll surface. The haze values of PC films showed a good correlation with the resilient rubber roll surface temperature as shown in FIG. 3. The air knife was installed underneath the rubber to facilitate the easy installation from a manufacturing point of view. The velocity of the air flow was kept below 8 meter per second (m/s) to reduce risk of disturbing the polymer melts.

What is claimed:

1. A film making process, comprising:
introducing a plastic melt to a nip between a calendar roll and a resilient roll;
passing the plastic melt between the calendar roll and the resilient roll to produce the film; and
controlling a roughness of the film by actively cooling an external surface of the resilient roll.

2. The process of claim 1, wherein cooling the external surface further comprises directing a gas stream at the external surface.

3. The process of claim 2, wherein cooling the external surface further comprises contacting the external surface with a chill roll.

4. The process of claim 1, wherein passing the plastic melt between the calendar roll and the resilient roll further comprises passing the plastic melt at a rate of greater than or equal to about 15 m/min to form a film having a thickness of about 0.050 mm to about 0.30 mm and a haze of less than or equal to about 40% as measured by ASTM D1003-95.

5. The process of claim 4, wherein the rate is greater than or equal to about 15 m/min.

6. The process of claim 5, wherein the rate is greater than or equal to about 20 m/min.

7. The process of claim 6, wherein the rate is greater than or equal to about 30 m/min.

8. The process of claim 1, wherein the plastic is selected from the group consisting of polycarbonate, mixtures comprising polycarbonate, compositions comprising polycarbonate, and reaction products formed from polycarbonate.

9. The process of claim 1, wherein the film has an optical retardation gradient of less than or equal to about 50 nm/in.

10. The process of claim 1, wherein the roughness is reduced by greater than or equal to about 25%, compared to a roughness value determined with the same calendar roll and the same resilient roll operated at a same rate, same melt temperature, and same nip pressure, and without the active cooling.

11. A film making process, comprising:
introducing a plastic melt having a melt temperature to a nip between a calendar roll and a resilient roll; and
passing the plastic melt between the calendar roll and the resilient roll to produce the film; and
wherein a point near and subsequent to where the melt contacts the resilient roll, is maintained at a roll temperature equal to the melt temperature minus a reduction temperature, and
wherein the reduction temperature is greater than or equal to about 50° F.

12. The process of claim 11, wherein the reduction temperature is greater than or equal to about 100° F.

13. The process of claim 12, wherein the reduction temperature is greater than or equal to about 125° F.

14. A film making process, comprising:
introducing a plastic melt to a nip between a calendar roll and a resilient roll;
actively cooling an external surface of the resilient roll; and
passing the plastic melt between the calendar roll and the resilient roll at a roll rate of greater than or equal to about 25% greater than a standard rate and attaining a rate surface roughness;
wherein the rate surface roughness is substantially equal to about a slow surface roughness attained if the same plastic melt is passed through the same calendar roll and the same resilient roll at the standard rate and without actively cooling the external surface.

15. The process of claim 14, wherein the roll rate is greater than or equal to about 50% greater than the standard rate.

16. The process of claim 15, wherein the roll rate is greater than or equal to about 100% greater than the standard rate.

17. The process of claim 14, wherein the actively cooling further comprises contacting the external surface with a gas stream.

18. The process of claim 14, wherein the actively cooling further comprises contacting the external surface with a chill roll.

19. The process of claim 18, wherein the chill roll has a temperature of less than or equal to about 40° C.

20. A film making process, comprising:
introducing a plastic melt having a melt temperature to a nip between a calendar roll and a resilient roll;
passing the plastic melt between the calendar roll and the resilient roll to produce the film; and
adjusting a roughness of the film at a constant production rate and a constant nip pressure.
